(19) United States
(12) Patent Application Publication
(10) Pub. No.: US 2007/0127065 A1
(43) Pub. Date: Jun. 7, 2007

(54) PRINTING APPARATUS, PRINTING SYSTEM, AND PRINTING METHOD

(76) Inventor: Ayako Nishizawa, Yokohama-shi (JP)

Correspondence Address: MORGAN & FINNEGAN, L.L.P., 3 WORLD FINANCIAL CENTER, NEW YORK, NY, 10281-2101, US

(21) Appl. No.: 11/566,823

(22) Filed: Dec. 5, 2006

(30) Foreign Application Priority Data
Dec. 7, 2005 (JP) 2005-353988

(51) Int. Cl. G06F 3/12

(52) U.S. Cl. 358/1.15; 358/1.14

(57) ABSTRACT

A printing system includes a printing apparatus and an external information processing apparatus that issues an interrupt print job. A schedule designation unit in the information processing apparatus designates the start time of an event requiring a handout to be printed by executing the interrupt print job in the printing apparatus. The printing apparatus stores the designated event start time and accepts the interrupt print job. An interrupt determination unit in the printing apparatus determines whether to give execution priority to the interrupt print job based on the relationship among a print job currently being executed, the interrupt print job, and the event start time.

### BACKGROUND OF THE INVENTION

1. Field of the Invention

The present invention relates to a printing apparatus, printing system, and printing method that allow interrupt printing.

2. Description of the Related Art

In recent years, situations have arisen in which a number of relatively small-scale companies will operate their offices or other functions in the same building or on the same floor and share a single high-performance printing apparatus. Similarly, several departments within a company may share one printing apparatus in the same building or on the same floor. In such situations, if a specific company or department occupies the printing apparatus for a long time in order to print a large number of pages, other companies or departments may not be able to use the printing apparatus even though they are may urgently need to print a document.

The conventional method for addressing such cases has been to contact the user of the shared printing apparatus to ask that interrupt their bulk print job, or possibly to use interrupt printing. However, even without the use of interrupt printing, some situations may allow a given print job to complete by a required time. For example, even if a given company or organization is using a printing apparatus for bulk printing, interrupt printing may not be necessary if only a few print jobs remain and will be soon complete. Forcing unnecessary interrupts in this manner is ineffective in terms of the print efficiency of the printing apparatus.

To solve this problem, a system capable of determining whether to permit or reject an interrupt request based on the processing time for a job currently being processed has been proposed (Japanese Patent Application Laid-Open No. 2003-122526). In this system, an interrupt request is rejected if the remaining processing time for a job is shorter than “minimum interrupt time” (the amount of current job remaining time less than which interrupt requests should be rejected), which is preset via a panel or other setting device. Therefore, as described above, if a print job currently being processed seems nearly finished at the point of the interrupt request, it is determined that the interrupt is unnecessary, and the interrupt request is rejected. In this manner, unnecessary interrupts can be avoided.

Another known invention is one which allows automatic selection of an optimal print mode for completing a print job within a maximum permissible print time, as designated by the user. Still another known invention is one which allows outputting of a print job with the highest image quality possible within the designated time (Japanese Patent Application Laid-Open No. 2004-310177, Japanese Patent Application Laid-Open No. 2003-341180).

However, the technique described in Japanese Patent Application Laid-Open No. 2003-122526 has the problem of being unable to perform flexible interrupt printing due to the fixed interruptible time. For example, if a large value is set for the minimum interruptible time, this may increase the frequency of rejected interrupts and cause a situation in which interrupt printing cannot be performed even though it may be an urgently needed. Conversely, setting a small value for the minimum interruptible time may lead to unnecessary interrupt requests being granted.

In addition, heretofore, it has been impossible using a printing apparatus in an interrupt printing system to know the urgency of a job and take it into consideration. This has prevented an accurate determination of whether to permit or reject interrupt requests.

### SUMMARY OF THE INVENTION

The present invention allows realization of a printing apparatus, printing system, and printing method capable of appropriately rejecting an interrupt request and ensuring that the current job is completed out by a given time.

According to one embodiment of the present invention, the fore-described problem is solved by providing a printing apparatus connected with at least one information processing apparatus over a network, comprising an accepting unit adapted to accept a print job and information about a time to finish printing to be performed based on the print job from the information processing apparatus, a determination unit adapted to determine whether or not the printing based on the print job accepted by the accepting unit will be finished by the time if the printing of the print job accepted by the accepting unit is to be started after printing of a print job currently being executed is finished, and a control unit adapted to start the printing of the print job accepted by the accepting unit after the printing of the print job currently being executed is finished if the determination unit determines that the printing will be finished, and to start the printing of the print job accepted by the accepting unit by suspending the printing of the print job currently being executed if the determination unit determines that the printing will not be finished.

According to another embodiment of the present invention, the fore-described problem is solved by providing a printing system comprising a printing apparatus that executes a print job and at least one information processing apparatus that issues an interrupt print job to the printing apparatus, and causing the printing apparatus to perform interrupt printing based on the interrupt print job, wherein the information processing apparatus comprises an issuing unit adapted to issue an interrupt print job, and a setting unit adapted to set information about a time to finish the printing to be performed based on the interrupt print job in the printing apparatus, and the printing apparatus comprises an accepting unit adapted to accept the interrupt print job from the information processing apparatus, and a determination unit adapted to determine whether or not to give execution priority to the interrupt print job based on the relationship among a print job currently being executed, the interrupt print job, and the information about the time to finish the printing.

According to further embodiment of the present invention, a printing method in a printing apparatus connected over a network with at least one information processing apparatus that issues an interrupt print job and sets information about a time to finish printing to be performed based on the interrupt print job, comprising the steps of accepting the interrupt print job from the information processing apparatus, and determining whether or not to give execution priority to the interrupt print job based on the relationship among a print job currently being executed, the interrupt print job, and the information about the time to finish the printing.

Further features of the present invention will be apparent from the following description of exemplary embodiments with reference to the attached drawings.

### BRIEF DESCRIPTION OF THE DRAWINGS

FIG. 1 is a block diagram showing the configuration of a printing system including a printing apparatus and a host computer that issues print jobs according to an embodiment of the present invention;

FIG. 2 is a cross-sectional view showing the configuration of an LBP 102 according to the embodiment of the present invention;

FIG. 3 is a block diagram showing the detailed configuration of the printing system in the first embodiment of the present invention;

FIG. 4 is a diagram showing exemplary screens for schedule registration and confirmation in the printing system according to the first embodiment of the present invention;

FIG. 5 is a diagram for describing in which cases urgent interrupt printing is permitted;

FIG. 6 is a flowchart for describing an interrupt process in the printing apparatus 302 according to the first embodiment;

FIG. 7 is a diagram showing a screen for designating a print finish time used in the case where the print finish time is designated at the point of interrupt designation instead of the schedule registration screen shown in FIG. 4;

FIG. 8 is a flowchart for describing an interrupt process in the printing apparatus 302 according to a second embodiment;

FIG. 9 is a diagram for describing exemplary warnings in the printing system according to a third embodiment of the present invention; and

FIGS. 10A to 10C are flowcharts for describing interrupt processes in the printing apparatus 302 according to the third embodiment for different cases.

### DESCRIPTION OF THE EMBODIMENTS

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

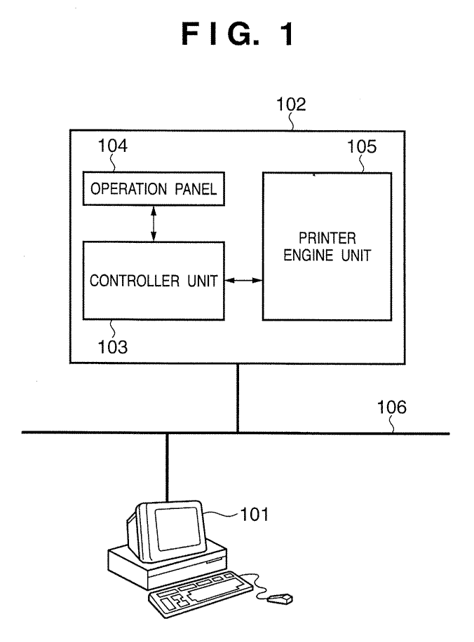

FIG. 1 is a block diagram showing the configuration of a printing system including a printing apparatus and a host computer that issues print jobs according to a first embodiment of the present invention. While a laser beam printer (LBP) is used in FIG. 1 as an example of the printing apparatus, this is not a limitation but any printer or digital multifunction printer (MFPs) using other printing schemes may be used.

In the printing system shown in FIG. 1, an LBP 102 connects with a plurality of external apparatuses such as host computers via a network 106 such as a LAN. In FIG. 1, only a host computer 101 is shown as the representation of the host computers.

The LBP 102 receives and stores as input print information (such as character codes), form information, or macro instructions provided by the externally-connected host computer 101. The LBP 102 also generates corresponding character or form patterns according to the received information and forms an image on a recording medium, i.e., a recording paper. In the LBP 102, a controller unit 103 is a printer control unit that controls the entire main body of the LBP 102 and analyzes the information provided by the host computer 101. The controller unit 103 connects to a printer engine unit 105 and generates page information containing dot data about patterns corresponding to the analyzed information in order to sequentially send the dot data (video signals) to the printer engine unit 105.

The printer engine unit 105 actually performs printing by forming a latent image on a photosensitive drum according to the dot data (video signals) and fixing the latent image onto the paper by heat fusing. An operation panel 104 has items such as operation switches and an LED display device arranged thereon, and receives operations from an operator (user). The operator can designate a specific operation or set the print environment for the LBP 102 by manipulating the operation panel 104. The operation panel 104 may display the status of the LBP 102 (e.g., an error occurrence state or an operator call) on the LED display device.

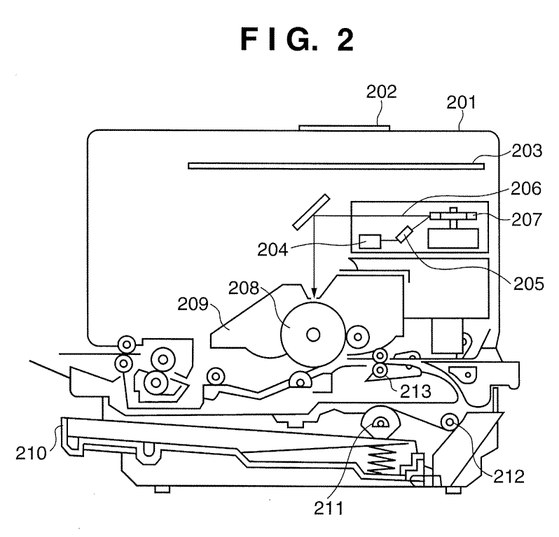

FIG. 2 is a cross-sectional view showing the configuration of the LBP 102 according to this embodiment. FIG. 2 mainly shows the configuration of the printer engine unit 105 in the configuration of the LBP 102. In FIG. 2, reference numeral 201 denotes the main body of the LBP and reference numeral 202 denotes the operation panel. A laser driver 204 is a circuit for driving a semiconductor laser 205 and switches a laser beam 206 emitted from the semiconductor laser 205 between on and off according to the video signals output by the control unit 203.

The laser beam 206 traverses and exposes an electrostatic drum 208 while being shuttled by a rotatable polygon mirror 207. This causes an electrostatic latent image such as character patterns to be formed on the electrostatic drum 208. This latent image is developed by a development unit 209 around the electrostatic drum 208 and then transferred to the recording paper. A cut sheet is used as the recording paper. The cut sheet recording paper, stored in a paper cassette 210 attached to the main body of the LBP 201, is taken into the LBP by a paper-feed roller 211 and conveying rollers 212 and 213 and fed to the electrostatic drum 208.

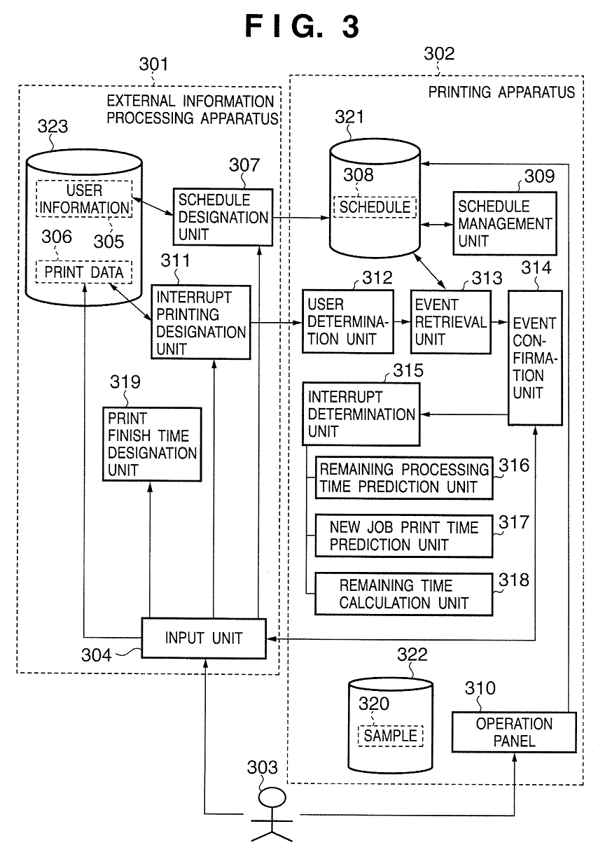

FIG. 3 is a block diagram showing the detailed configuration of the printing system in this embodiment. As shown in FIG. 3, the printing system in the first embodiment includes a printing apparatus 302 such as the above-described LBP, and an external information processing apparatus 301, such as the host computer, that generates print data.

The external information processing apparatus 301 includes an input unit 304, such as a driver user interface (a driver UI) and various application programs, operable by a user 303 to provide instructions to the printing apparatus 302. The external information processing apparatus 301 also includes a memory (a storage device) 323 that stores print data 306 generated by a user 303 via the input unit 304. The memory 323 also contains user information 305 uniquely provided to this external information processing apparatus 301, such as the computer name and IP address.

The external information processing apparatus 301 further includes a schedule designation unit 307 that informs the printing apparatus 302 of a print schedule generated by the user 303 via the input unit 304. In addition, the external information processing apparatus 301 includes: an interrupt printing designation unit 311 that designates interrupt printing when the print data 306 is going to be printed in the printing apparatus 302; and a print finish time designation unit 319 that designates the time required to finish printing of the print data 306.

Further, the printing apparatus 302 includes an operation panel 310 for the user 303 to directly manipulate the settings of the printing apparatus 302. The printing apparatus 302 also includes a memory (a storage device) 321 that stores the schedule 308 received from the external information processing apparatus 301, and a schedule management unit 309 that manages the schedule 308. The printing apparatus 302 further includes: a user determination unit 312 for determining a designating user when interrupt printing is designated; and an event retrieval unit 313 that retrieves the user's schedule to check before which meeting the user intends for printing to finish. The printing apparatus 302 further includes an event confirmation unit 314 that confirms the retrieved event, and an interrupt determination unit 315 that determines whether or not to permit the user's interrupt according to the schedule and the state of a job currently being processed.

The interrupt determination unit 315 includes the following units, each of which refers to a sample 320 registered with the memory 322 in the printing apparatus 302. That is, the interrupt determination unit 315 includes: a remaining processing time prediction unit 316 that predicts the time required for processing the remainder of the job currently being processed; a new job print time prediction unit 317 that predicts the time required for processing of an interrupting job; and a remaining time calculation unit 318 that calculates the time limit by which the interrupting job should be finished. Registered as the sample 320 are, for example, average required times per page for varying page sizes, color spaces, and resolutions. Then, information about the print data to be actually processed, such as the page size and the color space, is compared with information about the sample 320 to predict the time required for the processing.

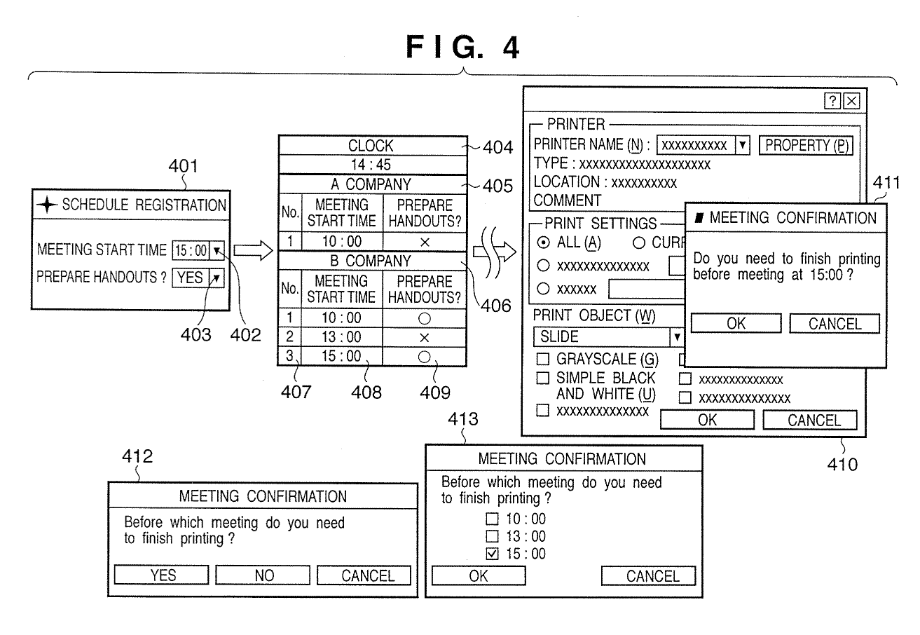

FIG. 4 is a diagram showing exemplary screens for schedule registration and confirmation in the printing system according to the first embodiment of the present invention. The user registers the print schedule with the printing apparatus 302 via a schedule registration screen 401 in advance. The schedule registration screen 401 may be part of the driver UI or may be a dedicated application program. This registration screen 401 is configured to allow making selections for registering the meeting start time 402 and registering whether handouts should be prepared or not 403. Once the user makes selections of these items, the information is sent from the external information processing apparatus 301 to the printing apparatus 302. At this point, the user information 305 is also automatically sent to the printing apparatus 302.

The printing apparatus 302 stores the information about the meeting start time and whether handouts should be prepared or not in the memory 321 along with the user information 305. For example, the content of the stored information is as shown in a table 404. That is, the meeting start time 408 and whether handouts should be prepared or not 409 are registered for each user (here, A company 405 and B company 406). For convenience of management, each of these information pairs is registered with a management number 407 added thereto.

When the user who has registered the schedule in this manner designates interrupt printing when attempting to print data via the driver UI 410, a confirmation screen 411 is displayed. The printing apparatus 302 refers to part of the schedule corresponding to the user in the schedule it manages. The printing apparatus 302 retrieves a meeting closest to the current time and queries the user via the screen 411 as to whether or not the print job should be finished before that meeting. If the user selects OK, the print job is processed by the time of the meeting. Interrupt printing is performed as necessary. If the user selects CANCEL, the print job is processed in a normal manner without interrupt printing.

The confirmation screen 411 may be in the form of a screen 412. In this case, the user can select among YES, NO, and CANCEL. If YES is selected, the print job is processed by the time of the meeting while interrupt printing is performed as necessary. If CANCEL is selected, the print job is processed in a normal manner without interrupt printing. Further, if NO is selected, it is determined that the print job should be finished before another meeting. Then, the schedule is referred to again to retrieve information about the next meeting. The user is again queried via the screen 412 as to whether the print job should be finished before that meeting.

Alternatively, the confirmation screen 411 may be in the form of a screen 413. In this case, the printing apparatus refers to the schedule to retrieve information about all meetings so that the user can select a meeting before which printing should be finished.

The operation panel capable of displaying these screens is provided in an external information processing apparatus such as a personal computer, or in the printing apparatus. This facilitates the user's registration of the schedule, including dates and times and meetings, and whether handouts should be prepared or not, with the printing apparatus. The printing apparatus can refer to the schedule concerned and readily predict which user is going to print handouts to be used in which event at a certain time, as well as the urgency of the printing.

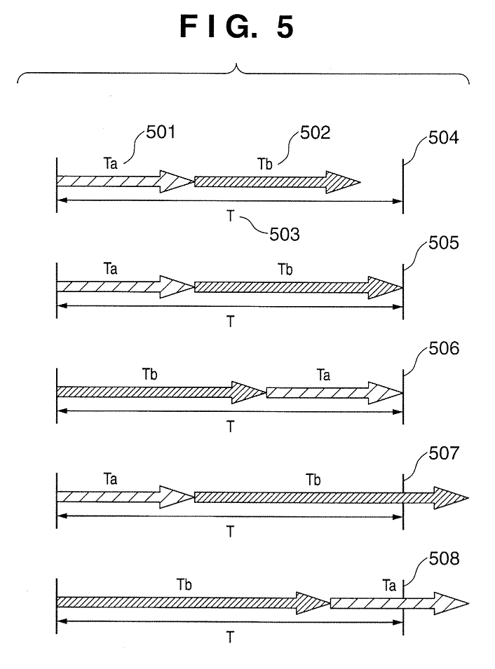

FIG. 5 is a diagram for describing in which cases urgent interrupt printing is permitted. FIG. 5 shows the situation in which print processing for a job a in the printing apparatus 302 is interrupted by print processing for a job b, which must be finished before a meeting to be held after a time T. Here, the time required for processing the remainder of the job currently being processed a is expressed as Ta, the time required for processing the job b for which interrupt printing is designated is expressed as Tb, and the time from the occurrence of the interrupt printing designation for job b to the start of the meeting before which the printing of b must be finished is expressed as T.

First, indicated at 504 is the case where Ta+Tb<T. Since the printing of both a and b will be finished by the time after T even if b interrupts a, the interrupt printing of b is not permitted (the rejection case).

Indicated at 505 is the case where Ta+Tb=T. Although printing will be finished by time T, it will be inconvenient for the owner of job b considering issues such as the time required to carry the printouts to the meeting site after from the printer. Therefore, this case permits interrupt printing. Once the interrupt is permitted, printing is performed in the order indicated at 506.

Further, indicated at 507 is the case where Ta+Tb>T, i.e., job b cannot be printed by time T. Therefore, this case permits job b to interrupt job a. Once the interrupt is permitted, printing is performed in the order indicated at 508.

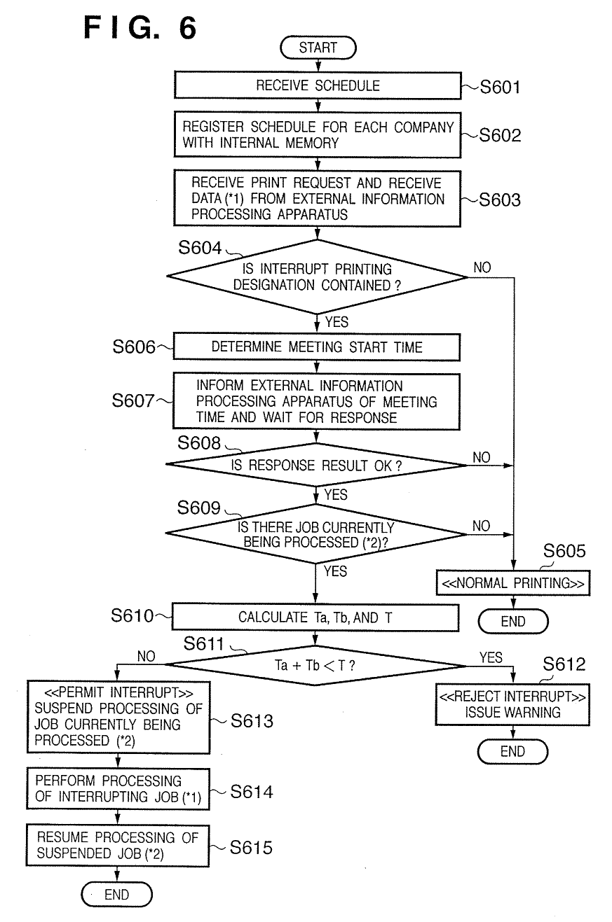

FIG. 6 is a flowchart describing the interrupt process in the printing apparatus 302 according to this embodiment. The printing apparatus 302 receives the schedule from the external information processing apparatus 301 (step S601) and registers the schedule as shown in the table 404 for each user in the internal memory (step S602).

The printing apparatus 302 then receives a print request and further receives print data from the external information processing apparatus 301 (step S603). It is checked whether the received print request contains an interrupt printing designation (step S604).

If no interrupt printing designation is contained (No), the job is added to the end of the print queue in a normal manner to start the print processing when its turn comes (step S605). If interrupt printing designation is contained, the schedule 404 is referred to and the closest meeting, or as described in FIG. 4, a list of meetings is retrieved to determine the meeting start time (step S606). This meeting information is sent to the external information processing apparatus 301 and a response is waited for (step S607). When a response is received, the response result is judged (step S608).

In this manner, the printing apparatus refers to the schedule and retrieves an event before determining whether to permit or reject the interrupt, and queries the user as to whether the time by which a given print job should be finished is the start time of that event. This allows the system to verify whether the event retrieval result is correct or not, and allows confirmation the event for which the user has requested an interrupt with the intention of having their print job finish before that event.

If the response result is not OK (No), the print job is treated normally and no interrupt printing is performed (step S605). If the response result is OK (Yes), whether or not there is a job currently being processed (step S609) is checked. If no job is currently being processed (No) at step S609, the interrupt is not necessary and print processing is started normally (step S605). If a job is currently being processed (Yes), the sample 320 is referred to and the time Tb required to print the submit job, the time Ta required for printing the remainder of the job currently being processed, and the time T left before the start of the meeting are calculated (step S610). These times are calculated from attributes of the data to be actually printed (such as the number of copies, the number of pages, the page size, the resolution, and the color space) obtained with reference to the sample 320. Thereafter, it is determined whether to permit or reject the interrupt as depicted in FIG. 5 (step S611).

In this manner, the decision of whether to permit or reject the interrupt is determined based on consideration of the time remaining until completion of the job to be interrupted, the time required to process the interrupting job, and the time remaining before the start time of the event. Therefore, it is possible to permit only truly required interrupts while preventing unnecessary interrupts.

If it is determined that the interrupt is rejected (Yes, i.e., Ta+Tb<T), a warning is issued to the external information processing apparatus 301 (step S612). Then, the job is added to the end of the print queue in a normal manner. If it is determined that the interrupt is permitted (No, i.e., Ta+Tb>T), processing of the job currently being processed is suspended (step S613) and the interrupting job is processed (step S614). Thereafter, processing of the suspended job is resumed (step S615).

Thus, this embodiment appropriately rejects print job interrupt requests and ensures that the current job is printed out by the desired time.

### Second Embodiment

For a second embodiment, description will be given of the case where the schedule is not registered with the printing apparatus 302. Since the general configuration of the printing system has been described using FIG. 3 in the first embodiment, it will not be described here.

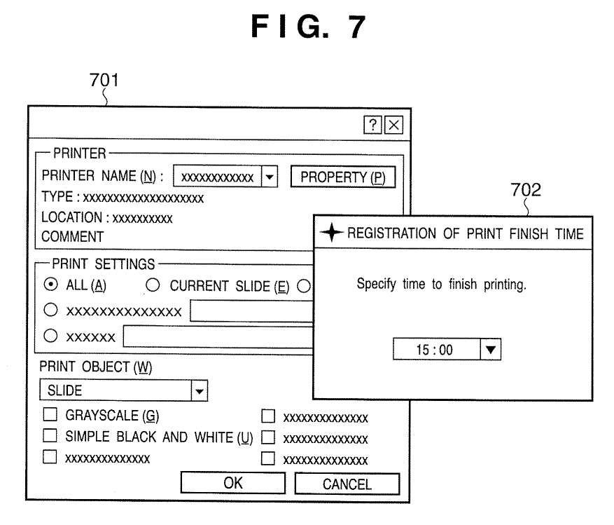

FIG. 7 is a diagram showing a screen for designating the print finish time used in the case where the print finish time is designated at the point of the interrupt designation instead of the schedule registration screen shown in FIG. 4. The user presses a certain button in the driver UI 701 when attempting the interrupt printing. This causes a screen 702 to be displayed. The user selects the time by which the printing should be finished on the screen 702 and attempts the interrupt printing via the driver UI 701. The printing apparatus 302 receives this information and performs the interrupt determination as shown in FIG. 5, considering the period from the current time to this designated time as T.

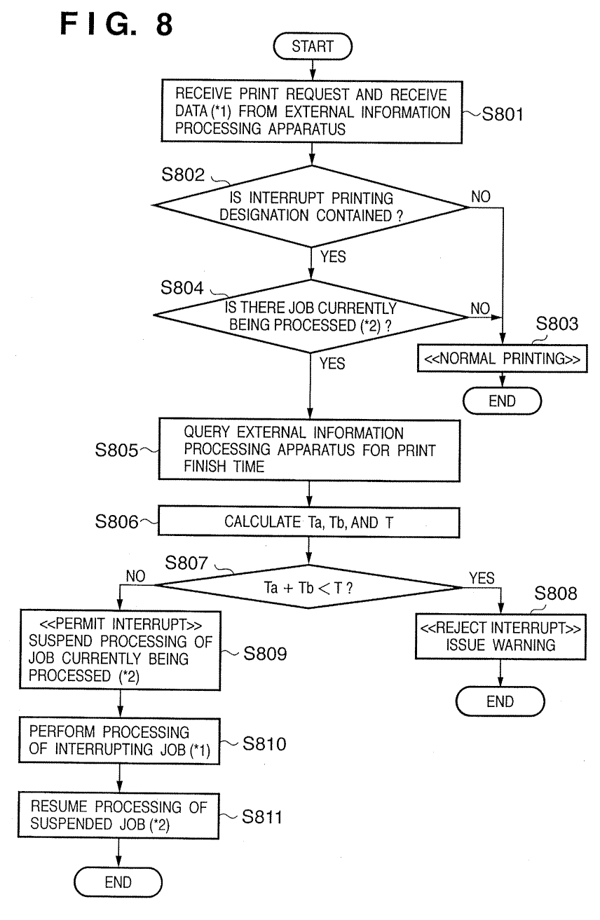

FIG. 8 is a flowchart for describing the interrupt process in the printing apparatus 302 according to the second embodiment. The printing apparatus 302 receives a print request and further receives print data from the external information processing apparatus 301 (step S801). It is then checked whether the received print request contains interrupt printing designation (step S802).

If no interrupt printing designation is contained (No), the job is added to the end of the print queue in a normal manner to start print processing when its turn comes (step S803). If interrupt printing designation is contained (Yes), it is checked whether there is a job currently being processed (step S804) If no job is being processed (No), the interrupt is not necessary and print processing is started in a normal manner (step S803). If a job is being processed (Yes), the external information processing apparatus 301 is queried for a desired time by which the printing should be finished (the print finish time T) (step S805).

In step S805, the sample 320 is referred to and the time Tb required for printing and the time Ta required for printing the remainder of the job currently being processed are calculated from attributes of the data to be actually printed (such as the number of copies, the number of pages, the page size, the resolution, and the color space) (step S806). Thereafter, the print finish time T is used to determine whether to permit or reject the interrupt as described in FIG. 5 (step S807).

In this manner, the printing apparatus is informed of the print finish time at the point of the interrupt printing designation. Therefore, even if the schedule is not registered, it is possible to consider the print finish time as the event start time and perform processing in the same manner as the case where the schedule is registered.

If it is determined in step S807 that the interrupt is rejected (Yes), i.e., Ta+Tb<T, a warning is issued to the external information processing apparatus 301 (step S808). Then, the job is added to the end of the print queue in a normal manner. If it is determined that the interrupt is permitted (No), i.e., Ta+Tb>T, the processing of the job currently being processed is suspended (step S809) and the printing of the interrupting job is processed (step S810). Thereafter, the processing of the suspended job is resumed (step S811).

Thus, this embodiment also appropriately rejects the interrupt print job and ensures that the current job is printed out by the set time.

### Third Embodiment

For a third embodiment, description will be given of the processing of the printing apparatus 302 in the case where Tb>T in the first and second embodiments. As in the above-described embodiments, the time required for processing the remainder of the job currently being processed a is expressed as Ta, the time required for processing the job b for which interrupt printing is designated is expressed as Tb, and the time from the occurrence of the interrupt printing designation for the job b to the start of the meeting before which the printing of b must be finished is expressed as T. The interrupt is permitted in the case 505 (Ta+Tb=T) and the case 507 (Ta+Tb>T) shown in FIG. 5.

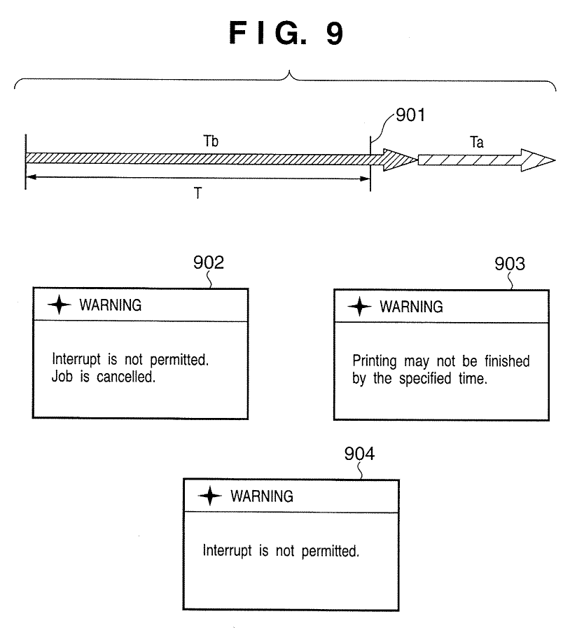

The case 507 includes the case of Tb>T. If Tb>T, as indicated at 901 in FIG. 9, the printing of b will not be finished within T although the interrupt is permitted. FIG. 9 is a diagram for describing exemplary warnings in the printing system according to the third embodiment of the present invention.

Therefore, if Tb>T, any of the following processing (A), (B), and (C) is performed.

(A) The interrupt by b is rejected and a warning 902 is provided to the user. The job b is canceled.

(B) The interrupt by b is permitted and a warning 903 is provided to the user. This is for finishing the printing as soon as possible although it will not be finished by the designated time even with the interrupt printing.

(C) The interrupt by b is rejected and a warning 904 is provided to the user. The job b is not treated as an interrupt job but is placed as a normal job at the end of the print queue and printed.

The warning may be displayed on the external information processing apparatus 301 that has sent the job, like the above-mentioned warnings 902 to 904, or may be displayed on the operation panel of the printing apparatus 302.

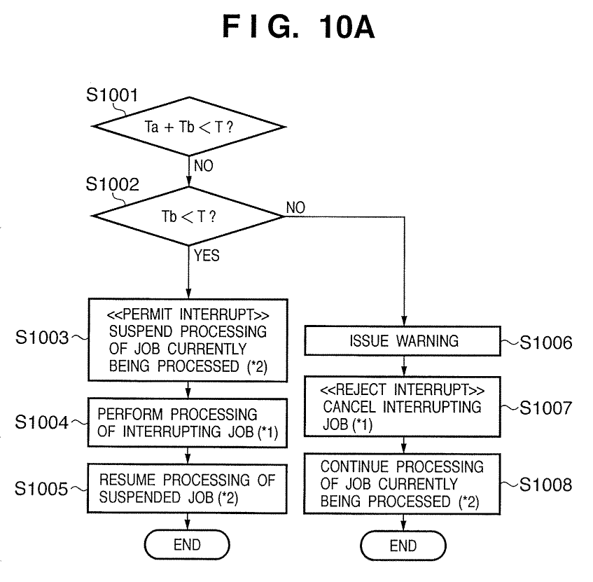

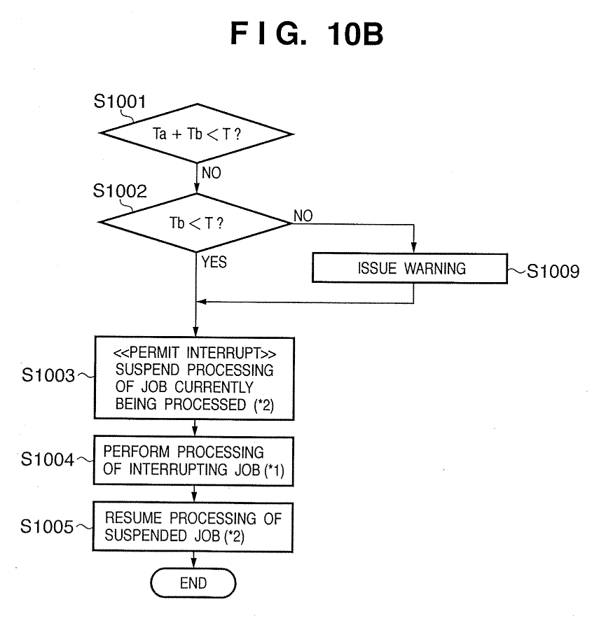

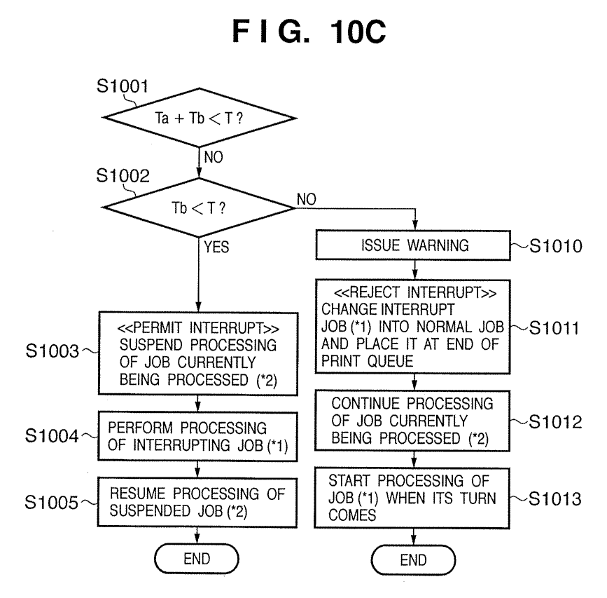

FIGS. 10A to 10C are flowcharts for describing the interrupt processes in the printing apparatus 302 according to the third embodiment for different cases. First, at step A1001, the same determination as at step S611 in FIG. 6 and step S807 in FIG. 8 shown for the first and second embodiments is performed. In the first and second embodiments, the interrupt printing is permitted if it is determined that Ta+Tb>T (No). In the third embodiment, it is further determined whether Tb<T (step S1002).

If Tb<T (Yes), the interrupt printing is permitted and processed as in the first and second embodiments (steps S1003 to S1005). If Tb>T (No) the following processing in FIGS. 10A to 10C is performed depending on the case.

First, in the case of FIG. 10A, a warning as indicated at 902 in FIG. 9 is issued to inform the user of the rejection of the interrupt and the cancellation of the job b (step S1006). Thereafter, the job b is cancelled (step S1007). As a result, the print processing of the job currently being processed a is continued without being interrupted (step S1008).

Next, in the case of FIG. 10B, a warning as indicated at 903 in FIG. 9 is issued (step S1009). However, the interrupt is permitted and thereafter the above-described interrupt processing is performed (steps S1003 to S1005).

Further, in the case of FIG. 10C, a warning as indicated at 904 in FIG. 9 is issued (step S1010) and the interrupt is rejected. The job b is not treated as an interrupt job but treated as a normal job, and is added to the end of the print queue (step S1011). As a result, the print processing of the job currently being processed a is continued without being interrupted (step S1012). The printing of the job b is started when its turn comes (step S1013).

Thus, this embodiment also appropriately rejects the interrupt print job and ensures that the current job is printed out by the set time.

### Other Embodiments

In situations where a number of companies or the like residing in the same building share one printing apparatus, there may be the following restriction for preventing specific companies from frequently interrupting.

For example, the number of possible interrupts per day for a company may be set, and interrupts exceeding that number are rejected. For this purpose, the printing apparatus may include a counter to count every interrupt made by each user (or company). The upper limit of the number of interrupts may be set in the printing apparatus in advance so that interrupts by users who have exceeded the number are rejected. In this manner, limiting the number of interrupts on a user basis or other bases can prevent the printing apparatus from being occupied by specific users who repeatedly interrupt.

There may also be a restriction that an interrupting company should bear part of the print charge to an interrupted company. In this case, the printing apparatus may include a billing system for this purpose.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-353988 filed on Dec. 7, 2005, which is hereby incorporated by reference herein in its entirety.

What is claimed is:

1. A printing apparatus connected with at least one information processing apparatus over a network, comprising:
an accepting unit adapted to accept a print job and information about a time to finish printing to be performed based on the print job from the information processing apparatus;
a determination unit adapted to determine whether or not the printing based on the print job accepted by the accepting unit will be finished by the time if the printing of the print job accepted by the accepting unit is to be started after printing of a print job currently being executed is finished; and
a control unit adapted to start the printing of the print job accepted by the accepting unit after the printing of the print job currently being executed is finished if the determination unit determines that the printing will be finished, and to start the printing of the print job accepted by the accepting unit by suspending the printing of the print job currently being executed if the determination unit determines that the printing will not be finished.

2. The printing apparatus according to claim 1, wherein the suspended print job is executed after the printing of the print job accepted by the accepting unit is finished.

3. The printing apparatus according to claim 1, further comprising a calculation unit adapted to calculate a time required for print processing of the remainder of the print job currently being executed, a time required for print processing of the print job accepted by the accepting unit, and a remaining time from a current time to the time to finish the printing accepted by the accepting unit,
wherein the determination unit determines based on the times calculated by the calculation unit.

4. The printing apparatus according to claim 1, further comprising:
a reception unit adapted to receive user identification information from the information processing apparatus: and
a management unit adapted to manage a limit value for the number of suspensions of the print job currently being executed for each user,
wherein the control unit causes print jobs of a user who exceeds the limit value for the number of suspensions of the print job currently being executed to be printed after printing of the print job currently being executed is finished.

5. The printing apparatus according to claim 1, further comprising a billing unit adapted to charge users who have issued print jobs for printing of the print jobs,
wherein the billing unit charges a print charge higher than normal to a user who has issued a print job printed by suspending a print job currently being executed.

6. The printing apparatus according to claim 5, wherein the billing unit charges a print charge lower than normal to a user who has issued the suspended print job.

7. A printing system comprising a printing apparatus that executes a print job and at least one information processing apparatus that issues an interrupt print job to the printing apparatus, and causing the printing apparatus to perform interrupt printing based on the interrupt print job, wherein
the information processing apparatus comprises:
an issuing unit adapted to issue an interrupt print job; and
a setting unit adapted to set information about a time to finish the printing to be performed based on the interrupt print job in the printing apparatus, and
the printing apparatus comprises:
an accepting unit adapted to accept the interrupt print job from the information processing apparatus; and
a determination unit adapted to determine whether or not to give execution priority to the interrupt print job based on the relationship among a print job currently being executed, the interrupt print job, and the information about the time to finish the printing.

8. A printing method in a printing apparatus connected over a network with at least one information processing apparatus that issues an interrupt print job and sets information about a time to finish printing to be performed based on the interrupt print job, comprising the steps of:
accepting the interrupt print job from the information processing apparatus; and
determining whether or not to give execution priority to the interrupt print job based on the relationship among a print job currently being executed, the interrupt print job, and the information about the time to finish the printing.

9. A control program for causing a computer to implement the printing method according to claim 8.
